(19) United States
(12) Patent Application Publication
(10) Pub. No.: US 2020/0283628 A1
(43) Pub. Date: Sep. 10, 2020

(54) MQ SILICONE RESINS

(71) Applicant: Dow Silicones Corporation, Midland, MI (US)

(72) Inventors: Zhi LI, Audubon, PA (US); Kimmai T. Nguyen, Midland, MI (US); Xianghuai Wang, Midland, MI (US)

(21) Appl. No.: 16/488,269

(22) PCT Filed: May 1, 2018
(86) PCT No.: PCT/US2018/030335

§ 371 Date: Aug. 23, 2019

Related U.S. Application Data
(60) Provisional application No. 62/515,066, filed on Jun. 5, 2017.

(51) Int. Cl. C08L 83/06; C08G 77/00; C08G 77/16

(52) U.S. Cl. CPC C08L 83/06; C08G 77/16; C08G 77/70

(57) ABSTRACT

A composition comprising an MQ resin having a silanol index of at least 1300 and a polysiloxane comprising polyether units.

This invention relates to a cosmetic composition comprising MQ resin which is useful in cosmetic applications.

Silicone compositions are known for use in cosmetic applications, see, e.g., U.S. Pat. No. 7,005,134. However, the known compositions do not provide good transfer resistance and sebum resistance.

### STATEMENT OF THE INVENTION

The present invention provides a cosmetic composition comprising:

a) MQ resin having a silanol index of at least 1300; and

b) a polysiloxane comprising polyether units.

### DETAILED DESCRIPTION

Percentages are weight percentages (wt %) and temperatures are in ° C. unless specified otherwise. Operations were performed at room temperature unless specified otherwise. As used herein, unless otherwise indicated, molecular weights, Mₙ, M_{w} and M_{z} have the conventional meanings and are determined by gel permeation chromatography. Molecular weights are reported herein in units of g/mol. Silanol index is determined by FT-IR as described in the Examples.

An “MQ resin” is a polysiloxane comprising units of [SiO_{4/2}] (Q units) and units of [(CH₃)₃SiO_{1/2}] (M units). Preferably, the MQ resin contains no more than 20 mole % of units other than M and Q (i.e., D and T units), preferably no more than 10 mole %, and preferably no more than 5 mole %. Preferably, the MQ resin has no [R¹R²SiO_{2/2}] (D) or [RSiO_{3/2}] (T) units. Preferably, the M/Q molar ratio is from 0.5:1 to 1.1:1, preferably from 0.6:1 to 1.0:1, preferably from 0.7:1 to 0.95:1. Preferably, the silanol index of the MQ resin is at least 1500, preferably at least 1700, preferably at least 1800, preferably at least 1900, preferably at least 1950; preferably no greater than 4500, preferably no greater than 3500.

Preferably, the polysiloxane comprising polyether units comprises units of [R¹R²SiO_{2/2}] (D units). Preferably, the siloxane units in the polysiloxane comprising polyether units comprise at least 70 mole % D units, preferably at least 80 mole %, preferably at least 90 mole %, preferably at least 95 mole %, preferably at least 98 mole %. Preferably, the polysiloxane comprising polyether units comprises polyether units as pendent units attached to silicon atoms or as blocks alternating with blocks of polysiloxane units (in the polymer backbone). Preferably, a polyether unit comprises from 2 to 4 carbon atoms. Preferably, polyether units comprise units of ethylene oxide and propylene oxide.

Preferably, the polysiloxane comprising polyether units has formula R¹R₂SiO(R₂SiO)ₐ(RXSiO)_{b}SiR₂R¹ or formula

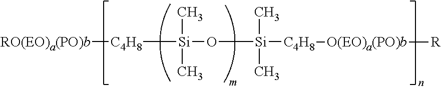

In formula R¹R₂SiO(R₂SiO)ₐ(RXSiO)_{b}SiR₂R¹, R is a C₁-C₂₀ hydrocarbyl group, X is a polyoxyalkylene group selected from the group consisting of R²(OC₂H₄)_{c}OR³, —R²(OC₂H₄)_{c}(OC₃H₆)_{d}OR³, —R²(OC₂H₄)ₑ(OC₄H₈)ₑOR³, —R²(OC₃H₆)ₐ(OC₄H₈)ₑOR³, and —R²(OC₂H₄)_{c}(OC₃H₆)ₐ(OC₄H₈)ₑOR³, wherein R¹ is R or X, R² is a divalent C₁-C₂₀ hydrocarbon radical, R³ is hydrogen, alkyl, aryl or acyl; a has an average value from 1 to 2000, b has an average value from 1 to 500; and c, d and e independently have an average value from 0.01 to 150.

In formula

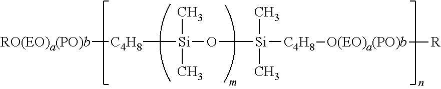

where the polysiloxane polyether comprises units of poly(oxyethylene/oxypropylene)/alkylene/methylpolysiloxane block copolymer, “R” represents a C₁-C₂₀ hydrocarbyl group, preferably an alkyl group, “a” represents an integer from 5 to 100, “b” represents an integer from 0 to 50, “m” represents an integer from 5 to 300, and “n” represents an integer from 1 to 40

Preferably, the cosmetic composition comprises from 1 to 40 wt % MQ resin and from 0.1 to 10 wt % polysiloxane comprising polyether units, based on total weight of the cosmetic composition; preferably from 3 to 30 wt % MQ resin and from 0.5 to 8 wt % polysiloxane comprising polyether units, preferably from 5 to 20 wt % MQ resin and from 0.8 to 5 wt % polysiloxane comprising polyether units. The composition may further comprise 0.5 to 50 wt % of coloring agent(s) (preferably 5 to 45, preferably 10 to 40), 0.1 to 60 wt % volatile solvent(s) (e.g., water and ethanol) (preferably 5 to 50, preferably 10 to 40) having viscosity of 0.5 to 50 cp at 25° C. (see U.S. Pat. No. 6,464,964 for examples of other volatile solvents).

Commercially available examples of MQ resins having a high silanol index include DOW CORNING RSN 0749 resin (silanol index circa 1740) and DOW CORNING MQ 1600 (silanol index circa 1980).

### EXAMPLES

Exemplary formulations containing MQ resin, Dow Corning FZ 2233 silicone polyether (a non-volatile silicone fluid), and pigment are shown below. The formulations are made by mixing all ingredients to form a homogenous mixture.

| | |
|---|---|
| Isododecane | 49.4% |
| Different MQ resins with different Silanol Index | 30.2% |
| Dow Corning FZ 2233 Silicone polyether | 12.8% |
| Red Iron Oxides Pigment | 7.6% |

Dow Corning® FZ-2233 is non-diluted block copolymerized poly(oxyethylene/oxypropylene)/alkylene/methylpolysiloxane copolymer. The general structure of this type of silicone polyether containing block polymer is

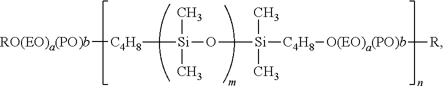

in which “R” represents an alkyl group, “a” is approximately 10, b is 8, m is approximately 40 and n is approximately 4.
Four MQ resins with different SiOH contents were used. Summarized below are the Silanol Index measurement method, as well as FTIR spectra and Silanol Index values obtained for the four MQ resins.

### Silanol Index Measurement:

An MQ resin's Silanol Index for MQ's non-hydrogen bonded surface SiOH is a value used to define a siloxane material's surface SiOH content. The higher an MQ resin's Silanol Index value, the higher surface SiOH content, thus the higher polarity enhancement. Silanol Index is defined by the following procedure involving FT-IR measurement and a subsequent data processing.

First, MQ in Carbon Tetrachloride solution was prepared. Accurate MQ concentration (weight to solvent volume) is obtained: for instance, dissolving 0.05 gram in 3 ml Carbon Tetrachloride resulted in a 1.67% (w/v ratio) MQ solution. FT-IR spectrum can then be obtained by scanning 3 ml MQ solution in an IR quartz cuvette with 1 cm optical pathway. A 64-scan is performed with a 4 cm′ spectral resolution.

Second, a reference spectrum of the same MQ sample is obtained using the same procedure described above, except that labile hydrogen atoms have been exchanged with deuterium. The deuterium exchange occurs by adding 0.5 ml D₂O to MQ solution in IR cell, shaking vigorously for 30 seconds, and allowing the phases to separate. Remove the D₂O layer and repeat with a fresh 0.5 ml of D₂O. Conduct IR scan after the above procedure is completed.

Third, a defined data processing procedure is applied to obtain MQ resin OH groups' IR bands. This procedure starts with subtracting the reference spectrum spectrally from the sample spectrum to remove all invariant features. The water absorbances near 3710 and 3610 cm⁻¹ are then removed by spectrally subtracting a permanently stored spectrum of water in Carbon Tetrachloride. The water in Carbon Tetrachloride spectrum is created by spectrally subtracting a scan of dry Carbon Tetrachloride from a scan of water-saturated Carbon Tetrachloride. The resulted final IR spectrum consists only of OH bands from the MQ resin.

Finally, in the final FT-IR spectrum OH signal peak around 3700 cm⁻¹, assigned to non-hydrogen bonded surface SiOH, is integrated to obtain OH Signal Area. Particularly, the Silanol Index value in this patent application is defined as: Silanol Index=OH Signal Area around 3700 cm⁻¹/MQ solution's concentration (w/v ration, in %). For instance, for a 1.67% (w/v) MQ solution, FT-IR measurement results an OH Signal Area of 33.07. The Silanol Index of this MQ resin is 1980, which is equal to 33.07/(1.67%).

| MQ resins | Silanol Index (Non-Bonded, ~3700 cm⁻¹) |
|---|---|
| High SiOH MQ | 1980 |
| MQ A | 1140 |
| MQ B | 960 |
| Low SiOH MQ | 198 |

Abrasion Test Setup and Procedure:

The test method is briefly described in the following steps: 1) Collagen films (VISCOFAN from Naturin GmbH & Co.) are secured tightly on 3×2.5 inch hard polycarbonate blocks. 2) ˜0.14 grams of each sample material/formulation is spread by finger on respective hydrated collagen films. The coated films are allowed to dry overnight. 3) To treat dried cosmetic films with artificial sebum prior to abrasion test, a small roller (˜1 inch) is used to gently spread ˜0.04 grams of artificial sebum on cosmetic film (coated on collagen). The treated films are left at ambient condition for 3-4 hours before abrasion testing. 4). Abrasion testing on all the artificial treated or non-treated films is conducted by using a modified Gardner Abrasion Tester. Up to 25 abrasion cycles may be applied to each sample. L*a*b values of both sample and rubbing cloth can be recorded by after abrasion cycles. Particularly, the “a” value from L 5). After abrasion, the visual appearance of both sample and rubbing cloth can also be recorded using digital camera. In addition, panel test can also be conducted to assess performance.

Results:

Four different formulations were prepared based on composition listed in Table 1, while each formulation using a different MQ resin with different silanol index. The digital image was shown to 8 panelists to assess which formulation showed least color transfer. Every panelist agreed that the formulation containing MQ resin with the highest Silanol Index (1980) showed the least color transfer.

The degree of color transfer was also characterized by colorimeter, which can provide an L*a*b reading to characterize surface color. The “a” value from L*a*b reading is correlated to surface “redness.” The higher “a” value, the more “redness” of surface color. Prior to abrasion test, an abrasion cloth is white in color and has an “a” value close to zero. After abrasion test, the higher “a” value of the abrasion cloth, the more red pigment transferred to.

Table 1 shows “a” values from colorimeter L*a*b readings of white abrasion cloths after 25 abrasion cycles without artificial sebum, while Table 2 shows “a” values from colorimeter L*a*b readings of white abrasion cloths after 25 abrasion cycles with artificial sebum pre-treatment. The results confirmed that the formulation containing MQ resin with the highest Silanol Index (1980) showed the least color transfer.

TABLE 1
“a” values from colorimeter L*a*b readings of
white abrasion cloths after 25 abrasion cycles
without artificial sebum. The higher “a” value, the
more red pigment transferred to abrasion cloth.

| Formulation with different | |
|---|---|
| MQ resins | “a” value |
| Formulation with High | 2.1 |
| Silanol MQ (Silanol Index | |
| 1980) | |
| MQ resin A (silanol index | 4.2 |
| 1140) | |
| MQ resin B (silanol index | 10.8 |
| 960) | |
| MQ resin B (silanol index | 11.2 |
| 198) | |

TABLE 2
“a” values from colorimeter L*a*b readings of white
abrasion cloths after 25 abrasion cycles with artificial
sebum. The high “a” value, the more red pigment
transferred to abrasion cloth.

| Formulation with different | |
|---|---|
| MQ resins | “a” value |
| Formulation with High | 2.9 |
| Silanol MQ (Silanol Index | |
| 1980) | |
| MQ resin A (silanol index | 3.4 |
| 1140) | |
| MQ resin B (silanol index | 6.3 |
| 960) | |
| MQ resin B (silanol index | 12.3 |
| 198) | |

1. A cosmetic composition comprising:
a) MQ resin having a silanol index of at least 1300; and
b) a polysiloxane comprising polyether units.

2. The cosmetic composition of claim 1 in which at least 90 mole % of siloxane units in said polysiloxane comprising polyether units are D units.

3. The composition of claim 2 in which the cosmetic composition comprises from 3 to 30 wt % MQ resin and from 0.5 to 8 wt % polysiloxane comprising polyether units.

4. The cosmetic composition of claim 3 in which the MQ resin has a silanol index of at least 1500.

5. The cosmetic composition of claim 4 in which the polysiloxane comprising polyether units comprises polyether units as pendent units attached to silicon atoms or as blocks alternating with blocks of polysiloxane units.

6. The cosmetic composition of claim 5 in which a polyether unit comprises from 2 to 4 carbon atoms.

7. The cosmetic composition of claim 6 in which the MQ resin has an M/Q molar ratio from 0.5:1 to 1.1:1.

8. The cosmetic composition of claim 7 in which the MQ resin has a silanol index of at least 1700.

9. The cosmetic composition of claim 8 in which at least 95 wt % of siloxane units in said polysiloxane comprising polyether units are D units.
